(19) United States
(12) Patent Application Publication
(10) Pub. No.: US 2010/0107874 A1
(43) Pub. Date: May 6, 2010

(54) SORBENT COMPOSITION, THE PREPARATION METHOD THEREOF, AND THE PROCESS FOR REMOVING SULFUR OXIDES AND NITROGEN OXIDES IN A FLUE GAS BY THE SORBENT COMPOSITION

(76) Inventors: Bing Du, Beijing (CN); Baoning Zong, Beijing (CN); Yibin Luo, Beijing (CN); Weijia Wang, Beijing (CN)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/611,094

(22) Filed: Nov. 2, 2009

(30) Foreign Application Priority Data
Oct. 31, 2008 (CN) 200810225611.0
Oct. 31, 2008 (CN) 200810225612.5
Nov. 20, 2008 (CN) 200810226916.3
Dec. 25, 2008 (CN) 200810246520.5
Feb. 12, 2009 (CN) 100910077703.3
Feb. 12, 2009 (CN) 200910077702.9
Mar. 12, 2009 (CN) 200910119514.8
Mar. 12, 2009 (CN) 200910119515.2
Mar. 12, 2009 (CN) 200910119516.7

(51) Int. Cl. B01D 53/04; B01J 20/08; B01J 20/10

(52) U.S. Cl. 95/129; 502/415; 502/410; 95/137

(57) ABSTRACT

Provided are a sorbent composition, the preparation method thereof, and the process for removing sulfur oxides and nitrogen oxides in a flue gas by the sorbent composition. The sorbent composition comprises at least one refractory inorganic oxide matrix, at least one metal component I and at least one metal component II, wherein each of the at least one refractory inorganic oxide matrix has a specific surface area of more than 130 m²/g, the at least one metal component I is selected from elements of Group IA and Group IIA in the Periodic Table of Elements, and the at least one metal component II is selected from transition metals of Group IIB, Group VIB, Group VIIB, and Group VIII in the Periodic Table of Elements, and wherein the at least one metal component II is present in at least two different valence-states, as characterized by the X-ray photoelectron spectroscopy.

This application claims benefit of priority under 35 U.S.C. §119 to Chinese patent application 200810225612.5, filed Oct. 31, 2008, Chinese patent application 200810225611.0, filed Oct. 31, 2008, Chinese patent application 200810226916.3, filed Nov. 20, 2008, Chinese patent application 200810246520.5 filed Dec. 25, 2008, Chinese patent application 200910077703.3, filed Feb. 12, 2009, Chinese patent application 200910077702.9, filed Feb. 12, 2009, Chinese patent application 200910119516.7, filed Mar. 12, 2009, Chinese patent application 200910119514.8, filed Mar. 12, 2009, and Chinese patent application 200910119515.2 filed Mar. 12, 2009.

Pollution from sulfur oxides SOx (more than 95% being SO₂) and nitrogen oxides NOx (more than 90% being NO) in the atmosphere is an increasingly serious problem. The flue gases produced from the combustion of fuels, smeltering of metals, or the like are main sources of the SOx and NOx. Those harmful gases are greatly adverse to the environment and human health. Although the technologies for SOx emission control have been relatively well established, the results for tNOx emission control are less satisfactory.

Provided is a sorbent composition, the preparation method thereof, and the process for removing sulfur oxides and/or nitrogen oxides in a flue gas using the sorbent composition.

### DESCRIPTION OF THE FIGURE

FIG. 1 is the XPS spectrum of the material obtained in example 2-1.

In some embodiments, the sorbent composition comprises at least one refractory inorganic oxide matrix, at least one metal component I and at least one metal component II, wherein each of the at least one refractory inorganic oxide matrix has a specific surface area of more than 130 m²/g, the at least one metal component I is selected from elements of Group IA and Group IIA in the Periodic Table of Elements, the at least one metal component II is selected from transition metals of Group IIB, Group VIB, Group VIIB, and Group VIII in the Periodic Table of Elements, and wherein the at least one metal component II is present in at least two different valence-states, as characterized by the X-ray photoelectron spectroscopy (XPS).

The sorbent composition may exhibit better adsorption property for the sulfur oxides and nitrogen oxides, and may be suitable for purifying the industry waste gas in order to simultaneously remove the sulfur oxides and nitrogen oxides.

In some embodiments, the sorbent composition comprises, based on the sorbent, the at least one refractory inorganic oxide matrix in an amount ranging from 50 to 99 wt %, such as 65 to 98 wt %, the at least one metal component I in an amount ranging from 0.5 to 35 wt %, such as 1 to 20 wt %, and the at least one metal component II in an amount ranging from 0.5 to 35 wt %, such as 1 to 18 wt %, wherein the amounts of the at least one metal component I and the at least one metal component II are calculated by the oxide thereof.

The at least one metal component I and the at least one metal component II in the sorbent composition can be present in one or more form(s) selected from oxides and salts with other components.

In some embodiments, the at least one metal component I is selected from Na and K of Group IA, and Ba, Mg, and Ca of Group IIA. In some embodiments, the at least one metal component I is selected from Na and K of Group IA. In some embodiments; the at least one metal component II is selected from Cr of Group VIB, Mn of Group VIIB, Co of Group VIII, and Zn of Group IIB.

As characterized by the X-ray photoelectron spectroscopy, the at least one metal component II in the sorbent composition may, in some embodiments, be present in at least two different valence-states, i.e. M_{II}ⁱ¹⁺ and M_{II}ⁱ²⁺ wherein M_{II} represents the at least one metal component II, and i1+ and i2+ represents the different valence-states of M_{II}.

In some embodiments, the at least one metal component II comprises Cr which is present in the valence-states of Cr⁶⁺ and Cr³⁺. In some embodiments, calculated by the element and based on the total amount of Cr, the amount of M_{II}ⁱ¹⁺ in the at least one metal component II having different valence-states may range, for example, from 70 to 90%, such as from 70 to 85%, and the amount of M_{II}ⁱ²⁺ may range from 10 to 30%, such as 15 to 30%, wherein i1<i2. Herein, the amount of the at least one metal component having different valence-states is equal to S_{MII}ⁱ/ΣS_{MII}ⁱ×100%, wherein, M_{II} represents Cr, i represents the valency of Cr (e.g. the i values for Cr⁶⁺ and Cr³⁺ are 6+ and 3+ respectively), S represents the area integration value of the corresponding characteristic peak of the Cr having different valencies in the ev˜I spectrum (generated from e.g. Origin 7.0 software), and ΣSⁱ_{M II} the sum of the area integration values of the characteristic peaks of the Cr having different valencies.

In some embodiments, the at least one metal component II comprises Mn which is present in the valence-states of Mn⁴⁺ and Mn²⁺. In some embodiments, calculated by the element and based on the total amount of Mn, the amount of M_{II}ⁱ¹⁺ in the at least one metal component having different valence-states may range from 10 to 30%, such as 15 to 30%, and the amount of M_{II}ⁱ²⁺ may range from 70 to 90%, such as 70 to 85%, wherein i1<i2. Herein, the amount of the at least one metal component having different valence-states is equal to S_{MII}ⁱ/ΣS_{MII}ⁱ×100%, wherein, M_{II} represents Mn, i represents the valency of Mn (e.g. the i values for Mn⁴⁺ and Mn²⁺ are 4+ and 2+ respectively), S represents the area integration value of the corresponding characteristic peak of the Mn having different valencies in the ev˜I spectrum, and ΣSⁱ_{M II} is the sum of the area integration values of the characteristic peaks of the Mn having different valencies.

In some embodiments, the at least one metal component II comprises Mn.

In some embodiments, the at least one metal component II comprises Co which is present in the valence-states of Co³⁺ and Co⁴⁺. In some embodiments, calculated by the element and based on the total amount of Co, the amount of M_{II}ⁱ¹⁺ in the at least one metal component II having different valence-states ranges from 10 to 30%, such as 15 to 30%, and the amount of M_{II}ⁱ²⁺ ranges from 70 to 90%, such as 70 to 85%, wherein i1<i2. Herein, the amount of the at least one metal component having different valence-states is equal to S_{MII}ⁱ/ΣS_{MII}ⁱ×100%, wherein, M_{II} represents Co, i represents the valency of Co (e.g. the i values for Co³⁺ and Co⁴⁺ are 3+ and 4+ respectively), S represents the area integration value of the corresponding characteristic peak of the Co having different valencies in the ev˜I spectrum, and ΣSⁱ_{M II} is the sum of the area integration values of the characteristic peaks of the Co having different valencies.

In some embodiments, the at least one metal component H comprises Zn which is present in the valence-states of Zn¹⁺ and Zn²⁺. In some embodiments, calculated by the element and based on the total amount of Zn, the amount of M_{II}ⁱ¹⁺ in the at least one metal component having different valence-states ranges from 10 to 28%, such as 12 to 25%, and the amount of M_{II}ⁱ²⁺ ranges from 72 to 90%, such as 75 to 88%, wherein i1<i2. Herein, the amount of the at least one metal component having different valence-states is equal to S_{MII}ⁱ/ΣS_{MII}ⁱ×100%, wherein, M_{II} represents Zn, i represents the valency of Zn (e.g. the i values for Zn¹⁺ and Zn²⁺ are 1+ and 2+ respectively), S represents the area integration value of the corresponding characteristic peak of the Zn having different valencies in the ev˜I spectrum, and ΣSⁱ_{M II} is the sum of the area integration values of the characteristic peaks of the Zn having different valencies.

In some embodiments, each of the at least one refractory inorganic oxide matrix having a specific surface area of more than 130 m²/g is selected from oxides having a specific surface area of more than 130 m²/g. In some embodiments, the at least one refractory inorganic oxide matrix is selected from alumina, silica, titania, magnesium oxide, silica-alumina, silica-magnesium oxide, silica-zirconia, silica-thoria, silica-beryllia, silica-titania, silica-zirconia, titania-zirconia, silica-aluminia-thoria, silica-alumina-titania, silica-alumina-magnesium oxide, and silica-alumina-zirconia. In some embodiments, each of the at least one refractory inorganic oxide matrix has a specific surface area of more than 150 m²/g. In some embodiments, the at least one refractory inorganic oxide matrix comprises alumina, silica, silica-alumina, or mixtures thereof. In some embodiments, the at least one refractory inorganic oxide matrix comprises γ-Al₂O₃.

In some embodiments, the sorbent composition provided herein comprises the at least one metal component I, the at least one metal component II (wherein the at least one metal component I and the at least one metal component II in the sorbent composition can be present in one or more form(s) selected from oxides and salts with other components), and the at least one refractory inorganic oxide matrix. In some embodiments, the sorbent composition further comprises at least one other component which can improve or is not adverse to the property of the sorbent composition. For example, in some embodiments, the sorbent composition may comprise at least one other component selected from Group IB, IIIB, IVB, and VB. in some embodiments, the sorbent composition may comprise at least one other component selected from Cu, Ce, La, and V. In some embodiments, based on the total amount of the composition, the amount of the at least one other component is not more than 35 wt %, such as not more than 17 wt %, and for example, not more than 15 wt %, relative to the total amount of the composition.

Also provided is a method for preparing a sorbent composition described herein, comprising:
(1) combining, such as by introducing, at least one metal component I and at least one metal component II with at least one refractory inorganic oxide matrix, each of said at least one refractory inorganic oxide matrix having a specific surface of more than 130 m²/g, and/or the precursor thereof, wherein the at least one metal component I is selected from elements of Group IA and Group IIA in the Periodic Table of Elements, and the at least one metal component II is selected from transition metals of Group IIB, Group VIB, Group VIIB, and Group VIII in the Periodic Table of Elements;
(2) heating the product obtained from above step (1) at a temperature ranging from 600° C. to 1100° C. for a time period ranging from 2 to 12 hrs, to obtain the sorbent composition.

In some embodiments, the heating temperature in the step (2) ranges from 620° C. to 1000° C., such as 650° C. to 960° C., for example, 700° C. to 800° C. In some embodiments, the heating time ranges from 2 to 12 hrs, such as 4 to 11 hrs.

In the step (1), the method for combining, such as by introducing, the at least one metal component I and the at least one metal component II with the at least one refractory inorganic oxide matrix and/or the precursor thereof is not limited. In some embodiments, the at least one refractory inorganic oxide matrix and/or the precursor thereof is directly mixed with the compound containing the at least one metal component I and/or the compound containing the at least one metal component II. In some embodiments, the at least one refractory inorganic oxide matrix and/or the precursor thereof is impregnated by the solution of the compound containing the at least one metal component I and/or the solution of the compound containing the at least one metal component II.

As appropriate, the composition described herein can be prepared into various forms for ease of operation, e.g. microspheres, spheres, tablets, bars, or the like. The forms can be produced by any conventional method known in the art. For example, forms can be prepared by mixing the compound containing the at least one metal component I and/or the compound containing the at least one metal component II with the at least one refractory inorganic oxide matrix and/or the precursor thereof, extruding, and heating. Alternatively, the at least one refractory inorganic oxide matrix and/or the precursor thereof can be prepared into a shaped carrier, and then the at least one metal component I and the at least one metal component II are combined using impregnation. During the extrusion, a suitable amount of extrusion aids and/or adhesives can be added to facilitate the extrusion. The types and amounts of the extrusion aids and adhesives are well-known to the artisan in the field of the preparation of shaped catalysts or sorbents.

In some embodiments, the sorbent composition further comprises at least one other component which, in some embodiments, can improve or is not adverse to the property of the sorbent composition. In some embodiments, the at least one other component is selected from Group IB, IIIB, IVB, and VB. In some embodiments, the at least one other component is selected from Cu, Ce, La, and V.

In some embodiments, the preparation method further comprises the steps of including the at least one other component. The method for including the at least one other component is not limited. The at least one other component can be included into the composition during the inclusion of the at least one metal component I and the at least one metal component II into the at least one refractory inorganic oxide matrix and/or the precursor thereof in step (1), or included separately. For example, the compound containing the at least one other component can be mixed into the sorbent composition during the direct mixing of the compound containing the at least one metal component I and/or the compound containing the at least one metal component II with the at least one refractory inorganic oxide matrix and/or the precursor thereof. Alternatively, the compound containing the at least one other component and the compounds containing the at least one metal components I and/or the at least one metal component II can be formulated into a mix solution, and then the at least one refractory inorganic oxide matrix and/or the precursor thereof are impregnated by the mix solution. It is also possible to separately formulate a solution of the at least one other component for impregnation, and then impregnate the carrier before or after combining the at least one metal components I and/or the at least one metal component II with the carrier. It is also possible to combine the at least one other component by means of impregnation after the step (2). In some embodiments, where the at least one other component is combined using impregnation after the step (2), there are drying and heating steps after the impregnation. The drying is a conventional method, and the method conditions are not particular limited. The heating step is a conventional method known in the art, and the conditions for heating comprises: a temperature ranging from 600 to 1100° C., such as 650 to 960° C., for example, 700° C. to 800° C. In some embodiments; a heating time ranging from 2 to 12 hrs, such as 4 to 11 hr, is used. Based on the total amount of the sorbent, the amount of the at least one other component selected from elements of Group IB, IIIB, IVB, and VB, such as one or more of Cu, Ce, La, or V is not more than 35 wt %, such as not more than 17 wt %, for example, not more than 15 wt %.

Also provided is a process for removing nitrogen oxides and/or sulfur oxides in flue gas, comprising, under the conditions for the adsorptive separation, contacting the flue gas containing nitrogen oxides and/or sulfur oxides with the sorbent composition described herein.

The contacting of the flue gas containing sulfur oxides and/or nitrogen oxides with the sorbent composition can be conducted in any adsorptive separation device, e.g. a fixed bed adsorption tower or fluidized bed adsorptive separation reactor.

The operation conditions for the adsorptive separation are not limited. In some embodiments, the contents of the sulfur and nitrogen oxides in the separated gas satisfy the requirements of “THE EMISSION STANDARD FOR THE BOILER AIR POLLUTANT (GB13271)”, i.e. the content of the sulfur oxides being less than 315 ppm in the separated gas, and the content of the nitrogen oxides in the separated gas being less than 300 ppm. In some embodiments, the operation conditions for the adsorptive separation comprise: a temperature ranging from 0 to 300° C., such as 0 to 100° C.; a volume space velocity of the feedstock gases ranging from 5000/hr to 50000/hr, such as 5000/hr to 35000/hr; and a pressure ranging from 0.1 to 3.0 MPa, such as 0.1 to 2.0 MPa.

In some embodiments, the process further comprises a regeneration step for the sorbent composition. There is no particular limit to the regeneration of the sorbent composition, provided that the property of the sorbent composition can be recovered sufficiently. In some embodiments, the method comprises

(1) contacting the sorbent composition to be generated with at least one reductive gas at a temperature ranging from 200° C. to 800° C. for a time period ranging from 0.5 to 5 hrs;

(2) contacting the product obtained in above step (1) with at least one oxygen-containing gas at a temperature ranging from 200° C. to 800° C. for a time period ranging from 0.5 to 3 hrs; and

(3) again contacting the product obtained in step (2) with at least one reductive gas at a temperature ranging from 200° C. to 800° C. for a time period ranging from 0.5 to 5 hrs, wherein the at least one reductive gas can be same or different to that in above step (1).

The regeneration can be carried out in an in-situ adsorption apparatus, or a conventional ex-situ apparatus, e.g. an ex-situ fixed bed regenerator. In some embodiments, the temperature in the step (1) may range from 250° C. to 700° C., such as 280° C. to 650° C. In some embodiments, the temperature in the step (2) may range from 250° C. to 700° C., such as 280° C. to 650° C. In some embodiments, the temperature in the step (3) may range from 250° C. to 700° C., such as 280° C. to 650° C. The temperatures in above steps (1), (2) and (3) may be the same or different from each other.

The at least one reductive gas can be any reductive substance which is vaporizable at the temperature. In some embodiments, at least one the reductive gas is chosen from carbon monoxide, hydrogen, methane, ethene, ethane, propylene, and propane. In some embodiments, a mixture of reductive gases is used. In some embodiments, the contacting time in the step (1) ranges from 0.5 to 4 hrs, such as 0.5 to 3.5 hrs. In some embodiments, the contacting time in the step (3) ranges from 0.5 to 4 hrs, such as 0.5 to 3.5 hrs. The amount of the at least one reductive gas is not limited, provided that a reductive atmosphere for the sorbent composition is sufficiently formed. In some embodiments, the volume space velocity in the step (1) ranges from 5000/hr to 50000/hr, such as 5000/hr to 35000/hr. In some embodiments, the volume space velocity in the step (3) ranges from 5000/hr to 50000/hr, such as 5000/hr to 35000/hr.

The at least one oxygen-containing gas can be any substance which can release oxygen at the temperature. In some embodiments, the at least one oxygen-containing gas is chosen from oxygen, air, a mixture of oxygen and nitrogen gas, a mixture of oxygen and argon gas, and a mixture of oxygen and helium gas. In some embodiments, the contacting time in the step (2) ranges from 0.5 to 3 hrs, such as 0.5 to 2.5 hrs. The amount of the at least one oxygen-containing gas is not limited, provided that an oxidative atmosphere for the sorbent composition is sufficiently faulted. In some embodiments, the volume space velocity in the step (2) ranges from 5000/hr to 50000/hr, such as 5000/hr to 25000/hr.

In some embodiments, the inert gas purging and replacing steps for the adsorption apparatus can also be included to satisfy the conditions for the contacting of the composition with the at least one reductive gas or at least one oxygen-containing gas. In some embodiments, the inert gas is selected from one or more of nitrogen, helium, argon, neon, krypton, xenon, and niton gas. The amount and time for purging are not limited, provided that the requirements for the purging step are sufficiently satisfied. In some embodiments, the volume space velocity of the insert gas is 5000/hr to 25000/hr, such as 10000/hr to 20000/hr. In some embodiments, the time ranges from 0.5 hr to 3.0 hr, such as 0.5 to 2 hr.

In some embodiments, when the contacting is conducted in a fixed bed adsorption tower, two or more adsorption towers are positioned, as the case may be, for switching operation to achieve a continuous process. When the adsorptive separation is switched between two towers, the reduction, oxidation and re-reduction in the regeneration process may be conducted alternately in a same tower. When the adsorptive separation is switched among more than two towers, the reduction, oxidation and re-reduction in the regeneration process may be conducted alternately in either a same tower or two or more towers.

The sorbent composition described herein can be used for the removal of the SOx and/or NOx from the flue gas. For example, it can be used in the treatment of the SOx and/or NOx in the catalytic cracking process flue gas, coal burning power plant flue gas, and steel refinery flue gas, the removal of the SOx and/or NOx from the refuse incineration flue gas, and the treatment of other flue gas containing SOx and/or NOx.

As used herein and in the appended claims, the singular forms “a”, “an”, and “the” include plural reference unless the context clearly dictates otherwise.

The following examples further describe and demonstrate illustrative embodiments within the scope of the present invention. The examples are given solely for illustration and are not to be construed as limitations of this invention as many variations are possible without departing from the spirit and scope thereof. Various modifications of the invention in addition to those shown and described herein should be apparent to those skilled in the art and are intended to fall within the appended claims.

Except to the extent stated otherwise, the chemical agents used in the examples are chemically pure.

The contents of the at least one metal component II having different valency-states are measured by X-ray photoelectron spectroscopy. The X-ray photoelectron spectroscopy is the PHI Quantera SXM from ULVAC-PH INC, wherein a monochromator and Al anode target are used, X ray beam is 9 μm to 1.5 mm, the energy resolution is equal to 0.5 eV, the sensitivity is 3M CPS, the incident angle is equal to 45°, and the vacuum degree of the analysis chamber is equal to 6.7×10⁻⁸ Pa.

The sputtering conditions comprises: spanning sputtergun Ar⁺, area 1×1 mm², sputtering rate of about 20 nm/min, power 2.0 KV, emission current 20 mA, and a nominal sample of thermally oxided SiO₂/Si. The sputtering results are generated from Origin 7.0 softerware to produce an ev(electron energy)˜I(intensity) spectrum, and the area integration values of the respective characteristic peaks are calculated therefrom. The contents of the metal having different valecies are calculated according to the following formula:

S_{MII}ⁱ/ΣS_{MII}ⁱ×100%.

The characteristic peaks of the metal having different valecies in the X ray photoelectron spectroscopy (ev˜I) can be determined with reference to the Handbook of X ray Photoelectron Spectroscopy (J. F. Moulder et.al, Perkin-Elmer Corporation: Eden Prairie, 1992, 2^{nd} version).

### COMPARATIVE EXAMPLE 1-1

Raw materials: silica carrier (specific surface area 162 m²/g), sphere, average particle diameter 1.22 mm, a product from the Changling Catalyst Plant; Mg(NO₃)₂, Cr(NO₃)₃, and La(NO₃)₃ were commercially available from the Beijing Chemical Works.

Preparation method: 263 g Cr(NO₃)₃ was dissolved by deionized water to 1 liter solution L1, 123 g La(NO₃)₃ was dissolved by deionized water to 1 liter solution L2, and 592 g Mg(NO₃)₂ solution was dissolved by deionized water to 1 liter solution L3. 1000 g SiO₂ carrier was sequentially impregnated with L1, L2, and L3 for 2 hrs, a drying step was conducted at 110° C. for 12 hrs after each impregnation step, and then the resultant mixture was heated at 600° C. for 10 hrs to obtain the composition La—Mg—Cr—SiO₂.

Composition: calculated by MgO, Cr₂O₃ and La₂O₃ respectively, the amount of Mg was 16 wt %, the amount of Cr was 5 wt %, and the amount of La was 4 wt %.

As characterized by the X-ray photoelectron spectroscopy, Cr was present only in the form of Cr³⁺.

### EXAMPLE 1-1

Raw materials: silica carrier (specific surface area 162 m²/g), sphere, average particle diameter 1.22 mm, a product from the Changling Catalyst Plant; Mg(NO₃)₂, Cr(NO₃)₃, and La(NO₃)₃ were commercially available from the Beijing Chemical Works.

Preparation method: 263 g Cr(NO₃)₃ was dissolved by deionized water to 1 liter solution L1, 123 g La(NO₃)₃ was dissolved by deionized water to 1 liter solution L2, 592 g Mg(NO₃)₂ solution was dissolved by deionized water to 1 liter solution L3. 1000 g SiO₂ carrier was sequentially impregnated with L1, L2, and L3 for 2 hrs, a drying step was conducted at 110° C. for 12 hrs after each impregnation step, and the resultant mixture was baked at 700° C. for 10 hrs to obtain the composition La—Mg—Cr—SiO₂.

Composition: calculated by MgO, Cr₂O₃ and La₂O₃ respectively, the amount of Mg was 16 wt %, the amount of Cr was 5 wt %, and the amount of La was 4 wt %.

As characterized by the X-ray photoelectron spectroscopy, Cr was present in at least the two different forms of Cr⁶⁺ and Cr³⁺. Calculated by the element and based on the total content of Cr⁶⁺ and Cr³⁺, the content of Cr³⁺ was 87%, and the content of Cr⁶⁺ was 13%.

### EXAMPLE 1-2

Raw materials: γ-Al₂O₃ carrier (specific surface area 180 m²/g), sphere, average particle diameter 1.3 mm, a product from the Changling Catalyst Plant; Cr(NO₃)₃, and K₂CO₃ were commercially available from the Beijing Chemical Works.

Preparation method: the composition K—Cr-γ-Al₂O₃ was subjected to a step-wise impregnation process as disclosed in Example 1-1. A drying step at 110° C. was conducted for 12 hrs after each impregnation step, and then the resultant composition was baked at 900° C. for 8 hrs.

Composition: calculated by K₂CO₃ and Cr₂O₃ respectively, the amount of K in K—Cr-γ-Al₂O₃ was 4 wt %, and the amount of Cr was 17 wt %.

As characterized by the X-ray photoelectron spectroscopy, Cr was present in at least the two different forms of Cr⁶⁺ and Cr³⁺. Calculated by the element and based on the total content of Cr⁶⁺ and Cr³⁺, the content of Cr³⁺ was 91%, and the content of Cr⁶⁺ was 9%.

### EXAMPLE 1-3

Raw materials: γ-Al₂O₃ carrier (specific surface area 180 m²/g), sphere, average particle diameter 1.3 mm, a product from the Changling Catalyst Plant; Mn(NO₃)₂(50 wt % solution), Cr(NO₃)₃, and Na₂CO₃ were commercially available from the Beijing Chemical Works.

Preparation method: the composition Na—Mn—Cr-γ-Al₂O₃ was subjected to a step-wise impregnation process as disclosed in Example 1-1. A drying step at 110° C. was conducted for 12 hrs after each impregnation step, and then the resultant composition was baked at 800° C. for 6 hrs.

Composition: calculated by Na₂CO₃, MnO₂, and Cr₂O₃ respectively, the amount of Na in Na—Mn—Cr-γ-Al₂O₃ was 16 wt %, the amount of Mn was 5 wt %, and the amount of Cr was 13 wt %.

As characterized by the X-ray photoelectron spectroscopy, Cr was present in at least the two different forms of Cr⁶⁺ and Cr³⁺. Calculated by the element and based on the total content of Cr⁶⁺ and Cr³⁺, the content of Cr³⁺ was 81%, and the content of Cr⁶⁺ was 19%; Mn was present in at least the two different forms of Mn⁴⁺ and Mn²⁺. Calculated by the element and based on the total content of Mn⁴⁺ and Mn²⁺, the content of Mn⁴⁺ was 85%, and the content of Mn²⁺ was 15%.

### EXAMPLE 1-4

Raw materials: γ-Al₂O₃ carrier (specific surface area 180 m²/g), sphere, average particle diameter 1.3 mm, a product from the Changling Catalyst Plant; Cr(NO₃)₃, Co(NO₃)₂, Na₂CO₃, and Ba(NO₃)₂ were commercially available from the Beijing Chemical Works.

Preparation method: the composition Na—Cr—Co—Ba-γ-Al₂O₃ was subjected to a step-wise impregnation process as disclosed in Example 1-1. A drying step at 110° C. was conducted for 12 hrs after each impregnation step, and then the resultant composition was baked at 680° C. for 5 hrs.

Composition: calculated by Na₂CO₃, Cr₂O₃, CO₃O₄, and BaO respectively, the amount of Na in Na—Cr—Co—Ba-γ-Al₂O₃ was 3 wt %, the amount of Cr was 10 wt %, the amount of Co was 8 wt %, and the amount of Ba was 8 wt %.

As characterized by the X-ray photoelectron spectroscopy, Cr was present in at least the two different forms of Cr⁶⁺ and Cr³⁺. Calculated by the element and based on the total content of Cr⁶⁺ and Cr³⁺, the content of Cr³⁺ was 85%, and the content of Cr⁶⁺ was 15%.

### EXAMPLE 1-5

Raw materials: γ-Al₂O₃ carrier (specific surface area 180 m²/g), sphere, average particle diameter 1.3 mm, a product from the Changling Catalyst Plant; Cr(NO₃)₃, Cu(NO₃)₂, and Na₂CO₃ were commercially available from the Beijing Chemical Works.

Preparation method: the composition Na—Cr—Cu-γ-Al₂O₃ was subjected to a step-wise impregnation process as disclosed in Example 1-1. A drying step at 110° C. was conducted for 12 hrs after each impregnation step, and then the resultant composition was baked at 750° C. for 4 hrs.

Composition: calculated by Na₂CO₃, Cr₂O₃, and CuO respectively, the amount of Na in Na—Cr—Cu-γ-Al₂O₃ was 8 wt %, the amount of Cr was 3 wt %, and the amount of Cu was 15 wt %.

In the composition, Cr was present in at least the two different forms of Cr⁶⁺ and Cr³⁺. Calculated by the element and based on the total content of Cr⁶⁺ and Cr³⁺, the content of Cr³⁺ was 86%, and the content of Cr⁶⁺ was 14%.

### EXAMPLE 1-6

Raw materials: γ-Al₂O₃ carrier (specific surface area 180 m²/g), sphere, average particle diameter 1.3 mm, a product from the Changling Catalyst Plant; Cr(NO₃)₃, Zn(NO₃)₂, and Na₂CO₃ were commercially available from the Beijing Chemical Works.

Preparation method: the composition Na— Cr —Zn-γ-Al₂O₃ was subjected to a step-wise impregnation process as disclosed in Example 1-1. A drying step at 110° C. was conducted for 12 hrs after each impregnation step, and then the resultant composition was baked at 950° C. for 6 hrs.

Composition: calculated by Na₂CO₃, Cr₂O₃, and ZnO respectively, the amount of Na in Na— Cr —Zn-γ-Al₂O₃ was 18 wt %, the amount of Cr was 8 wt %, and the amount of Zn was 10 wt %.

As characterized by the X-ray photoelectron spectroscopy, Cr was present in at least the two different forms of Cr⁶⁺ and Cr³⁺. Calculated by the element and based on the total content of Cr⁶⁺ and Cr³⁺, the content of Cr³⁺ was 80%, and the content of Cr⁶⁺ was 20%.

### EXAMPLE 1-7

The sorbent used in the experiment was La—Mg—Cr— SiO₂ prepared in Example 1-1. The experiment was conducted on a fixed bed continuous flow reactor. The reactor had an inside diameter of 8 mm. The material for removing the sulfur and nitrogen substances was used in an amount of 1 g. The adsorption temperature was 175° C. The volume flow rate of the feedstock gas was 300 ml/min. The volume composition of the feedstock gas was: 0.3% SO₂; 0.1% NO; 4.5% O₂; and the balance being N₂. Before the feedstock gas was fed, the material bed layer for removing the sulfur and nitrogen substances was purged by N₂ in a volume flow rate of 300 ml/min at 300° C. for 1 hr and then cooled to the adsorption temperature. The adsorption experiment was stopped when the concentration of the adsorbed tail gas tended to be stable. A SO₂ and NO analysis instrument was connected to the exit of the reactor to monitor the changes of the amounts of SO₂ and NO in the flue gas, wherein the SO₂, and the NO saturated adsorption capacity of the composition was calculated by the FIREFOX software developed by KANE Company, British (the same below). In this experiment, the SO₂ saturated adsorption capacity was 1.284 mmol/g, and the NO saturated adsorption capacity was 0.389 mmol/g.

Similarly, the sorbent composition prepared in Example 1-3 was tested, and the test results showed the SO₂ saturated adsorption capacity was 1.337 mmol/g, and the NO saturated adsorption capacity was 0.446 mmol/g.

### COMPARATIVE EXAMPLE 1-2

The sorbent used in the experiment was La—Mg—Cr— SiO₂ prepared in Comparative Example 1-1. The experiment was conducted on a fixed bed continuous flow reactor. The reactor had an inside diameter of 8 mm. The material for removing the sulfur and nitrogen substances was used in an amount of 1 g. The adsorption temperature was 50° C. The volume flow rate of the feedstock gas was 300 ml/min. The volume composition of the feedstock gas was: 0.3% SO₂; 0.1% NO; 4.5% O₂; and the balance being N₂. Before the feedstock gas was fed, the material bed layer for removing the sulfur and nitrogen substances was purged by N₂ in a volume flow rate of 300 ml/min at 300° C. for 1 hr and then cooled to the adsorption temperature. The adsorption experiment was stopped when the concentration of the adsorbed tail gas tended to be stable, and then N₂ was used to purge the residual mix gas in the tube wall for 10 mins. A SO₂ and NO analysis instrument was connected to the exit of the reactor to monitor the changes of the amounts of SO₂ and NO in the flue gas. In the experiment, the SO₂ saturated adsorption capacity was 1.201 mmol/g, and the NO saturated adsorption capacity was 0.310 mmol/g.

### EXAMPLE 1-8

The sorbent to be regenerated was the adsorption-saturated samples in Example 1-7, represented by SORB1-1 (the sorbent of Example 1-1) and SORB1-2 (the sorbent of Example 1-3). The regeneration was conducted on an ex-situ regenerator which was a tube reactor having an inside diameter of 10 mm.

1 g SORB1-1 to be regenerated was placed in the reactor device. The temperature in the reactor was increased to 350° C. in a temperature ramp rate of 10° C./min under the nitrogen purge in a space velocity of 10000/hr. After being stable for 30 mins, the nitrogen purge was stopped, and then at the regeneration temperature of 350° C., the SORB1-1 to be regenerated was contacted with CO gas in a space velocity of 15000/hr for 2 hrs (step 1); the reactor was purged by nitrogen gas in a space velocity of 10000/hr for 30 mins, and then the SORB1-1 reduced in the previous step was contacted with oxygen gas in a space velocity of 15000/hr for 30 mins (step 2); the reactor was purged by nitrogen gas in a space velocity of 10000/hr for 30 mins, and then the SORB1-1 oxidized in the previous step was contacted with methane gas in a space velocity of 15000/hr for 1 hr (step 3); subsequently, nitrogen gas was fed in a space velocity of 10000/hr to purge the reactor until the temperature of the reactor was decreased to the ambient temperature. Accordingly, the regenerated sorbent composition SORB1-1-1 was obtained.

The SORB1-1-1 was evaluated according to the evaluation conditions of Example 1-7. The experimental results were: the SO₂ saturated adsorption capacity was 1.080 mmol/g (84.1% of the capacity of the fresh sorbent), and the NO saturated adsorption capacity was 0.378 mmol/g (97.1% of the capacity of the fresh sorbent).

SORB1-2 was tested similarly, except that the regeneration temperature was 600° C., and the times for contacting with the reductive or oxidative gas in regeneration steps (1), (2) and (3) were 1 hr, 2 hrs and 3 hrs respectively. The experimental results were: the SO₂ saturated adsorption capacity was 1.201 mmol/g (89.8% of the capacity of the fresh sorbent), and the NO saturated adsorption capacity was 0.412 mmol/g (92.3% of the capacity of the fresh sorbent).

### COMPARATIVE EXAMPLE 1-3

The sorbent to be regenerated was the adsorption-saturated samples in Comparative Example 1-2, and the regeneration steps were same to those for SORB1-1 in Example 1-8.

The evaluation conditions for the regenerated sample were same to those in Comparative Example 1-2. The experimental results were: the SO₂ saturated adsorption capacity was 0.785 mmol/g (63.3% of the capacity of the fresh sorbent), and the NO saturated adsorption capacity was 0.241 mmol/g (58.6% of the capacity of the fresh sorbent).

### COMPARATIVE EXAMPLE 2-1

Raw materials: γ-Al₂O₃ carrier (specific surface area 180 m²/g), sphere, average particle diameter 1.3 mm, a product from the Changling Catalyst Plant; Ba(NO₃)₂, La(NO₃)₃, and 50 wt % Mn(NO₃)₂ solution (all being commercially available from the Beijing Chemical Works).

Preparation method: 25 g Ba(NO₃)₂ was dissolved by deionized water to 1 liter solution L1, 100 g La(NO₃)₃ was dissolved by deionized water to 1 liter solution L2, 542 g Mn(NO₃)₂ solution was dissolved by deionized water to 1 liter solution L3. 1000 g γ-Al₂O₃ carrier was sequentially impregnated with L1, L2, and L3 for 2 hrs, a drying step was conducted at 110° C. for 12 hrs after each impregnation step, and the resultant mixture was baked at 600° C. for 10 hrs to obtain the composition La—Mn—Ba-γ-Al₂O₃.

Composition: the loading amounts of the components were calculated by BaO, MnO₂ and La₂O₃ respectively; the amount of Ba was 1 wt %, the amount of Mn was 13 wt %, and the amount of La was 4 wt %.

As characterized by the X-ray photoelectron spectroscopy, Mn was present in the focus of Mn⁴⁺, and no other valency form of Mn was detected.

### EXAMPLE 2-1

Raw materials: same to Comparative Example 2-1.

Preparation method: 25 g Ba(NO₃)₂ was dissolved by deionized water to 1 liter solution L1, 100 g La(NO₃)₃ was dissolved by deionized water to 1 liter solution L2, and 542 g Mn(NO₃)₂ solution was dissolved by deionized water to 1 liter solution L3. 1000 g γ-Al₂O₃ carrier was sequentially impregnated with L1, L2, and L3 for 2 hrs, a drying step was conducted at 110° C. for 12 hrs after each impregnation step, and the resultant mixture was baked at 900° C. for 10 hrs, giving the composition La—Mn—Ba-γ-Al₂O₃.

Composition: the loading amounts of the components were calculated by BaO, MnO₂ and La₂O₃ respectively; the amount of Ba was 1 wt %, the amount of Mn was 13 wt %, and the amount of La was 4 wt %.

As characterized by the X-ray photoelectron spectroscopy, Mn was present in at least the two different forms of Mn⁴⁺ and Mn²⁺. Calculated by the element and based on the total content of Mn⁴⁺ and Mn²⁺, the content of Mn⁴⁺ was 75%, the content of Mn²⁺ was 25%.

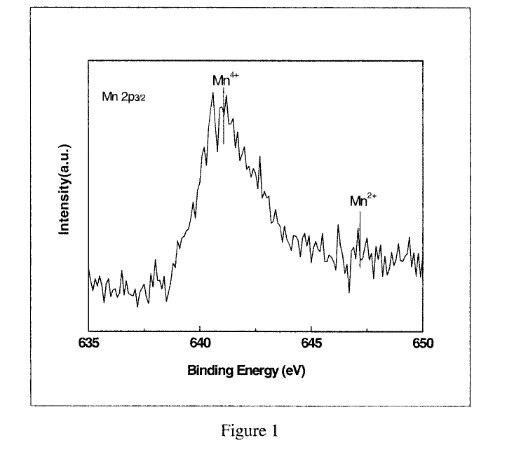

The corresponding XPS spectrum was shown in FIG. 1.

### COMPARATIVE EXAMPLE 2-2

Raw materials: γ-Al₂O₃ carrier (specific surface area 180 m²/g), sphere, average particle diameter 1.3 mm, a product from the Changling Catalyst Plant. Na₂CO₃, Cu(NO₃)₂, and La(NO₃)₃ were commercially available from the Beijing Chemical Works.

Preparation method: 85 g Na₂CO₃, 158 g Cu(NO₃)₂ and 124 g La(NO₃)₃ were dissolved by deionized water to 1 liter solution. The solution was used to impregnate 1000 g γ-Al₂O₃ carrier at ambient temperature for 2 hrs, followed by drying the impregnated carrier at 110° C. for 12 hrs, and the resultant mixture was baked at 800° C. for 10 hrs, giving the reference composition La—Cu—Na-γ-Al₂O₃.

Composition: the loading amounts of the components were calculated by Na₂CO₃, CuO and La₂O₃ respectively; the amount of Na was 8 wt %, the amount of Cu was 5 wt %, and the amount of La was 5 wt %.

### COMPARATIVE EXAMPLE 2-3

### Comparison for the Carriers)

Raw materials: Kaolin (specific surface area 28 m²/g), Na₂CO₃, Mn(NO₃)₂, and La(NO₃)₃ were commercially available from the Beijing Chemical Works.

Preparation method: 85 g Na₂CO₃, 160 g Mn(NO₃)₂ and 132 g La(NO₃)₃ were dissolved by deionized water to 1 liter solution. The solution was used to impregnate 1000 g Kaolin carrier at ambient temperature for 2 hrs, followed by drying the impregnated carrier at 110° C. for 12 hrs, and the resultant mixture was baked at 800° C. for 10 hrs, giving the composition La—Mn—Na-Kaolin.

Composition: the loading amounts of the components were calculated by Na₂CO₃, MnO₂ and La₂O₃ respectively; the amount of Na was 8 wt %, the amount of Mn was 6 wt %, and the amount of La was 6 wt %.

### EXAMPLE 2-2-1

Raw materials: γ-Al₂O₃ carrier (specific surface area 180 m²/g), sphere, average particle diameter 1.3 mm, a product from the Changling Catalyst Plant. Na₂CO₃, Mn(NO₃)₂, and La(NO₃)₃ were commercially available from the Beijing Chemical Works.

Preparation method: 85 g Na₂CO₃, 153 g Mn(NO₃)₂ and 124 g La(NO₃)₃ were dissolved by deionized water to 1 liter solution. The solution was used to impregnate 1000 g γ-Al₂O₃ carrier at ambient temperature for 2 hrs, followed by drying the impregnated carrier at 110° C. for 12 hrs, and the resultant mixture was baked at 800° C. for 10 hrs, giving the composition La—Mn—Na-γ-Al₂O₃.

Composition: the loading amounts of the components were calculated by Na₂CO₃, MnO₂ and La₂O₃ respectively; the amount of Na was 8 wt %, the amount of Mn was 5 wt %, and the amount of La was 5 wt %.

As characterized by the X-ray photoelectron spectroscopy, Mn was present in at least the two different forms of Mn⁴⁺ and Mn²⁺. Calculated by the element and based on the total content of Mn⁴⁺ and Mn²⁺, the content of Mn⁴⁺ was 78%, and the content of Mn²⁺ was 22%.

### EXAMPLE 2-2-2,2-2-3 AND 2-2-4

The raw materials and preparation methods were same to those in above Example 2-2-1, except that the refractory inorganic oxide matrix having a specific surface area of 132 m²/g(a silica from QiLu Catalyst Plant), 155 m²/g(a silica from LanZhou Catalyst Plant) and 170 m²/g(a γ-Al₂O₃ from QiLu Catalyst Plant) were used. The Mn in all the resultant compositions was present in at least the two different forms of Mn⁴⁺ and Mn²⁺.

### EXAMPLE 2-3

Raw materials: γ-Al₂O₃ carrier (specific surface area 180 m²/g), sphere, average particle diameter 1.22 mm, a product from the Changling Catalyst Plant; Mn(NO₃)₂(50 wt % solution), and K₂CO₃ were commercially available from the Beijing Chemical Works.

40 g K₂CO₃ was dissolved by deionized water to 1 liter solution L1, and 535 g Mn(NO₃)₂ solution was dissolved by deionized water to 1 liter solution L2. 1000 g γ-Al₂O₃ carrier was sequentially impregnated with L1 and L2 for 2 hrs, a drying step was conducted at 110° C. for 12 hrs after each impregnation step, and the resultant mixture was baked at 750° C. for 8 hrs, giving the composition K—Mn-γ-Al₂O₃.

Calculated by K₂CO₃ and MnO₂, the amount of K in K—Mn-γ-Al₂O₃ composition was 4 wt %, and the amount of Mn was 13 wt %.

As characterized by the X-ray photoelectron spectroscopy, Mn was present in at least the two different forms of Mn⁴⁺ and Mn²⁺. Calculated by the element and based on the total content of Mn⁴⁺ and Mn²⁺, the content of Mn⁴⁺ was 71%, and the content of Mn²⁺ was 29%.

### EXAMPLE 2-4

Raw materials: γ-Al₂O₃ carrier (specific surface area 180 m²/g), sphere, average particle diameter 1.3 mm, a product from the Changling Catalyst Plant; Mn(NO₃)₂(50 wt % solution), Co(NO₃)₂, Na/CO₃, and Ba(NO₃)₂ were commercially available from the Beijing Chemical Works.

The sample was prepared by a step-wise impregnation process. A drying step at 110° C. was conducted for 12 hrs after each impregnation step, the resultant was baked at 680° C. for 6 hrs, and the other preparation steps were same to those in Example 2-1. The composition Na—Mn—Co—Ba-γ-Al₂O₃ was prepared; calculated by Na₂CO₃, MnO₂, CO₃O₄ and BaO respectively, the amount of Na was 6 wt %, the amount of Mn was 10 wt %, the amount of Co was 8 wt %, and the amount of Ba was 5 wt %.

As characterized by the X-ray photoelectron spectroscopy, Mn was present in at least the two different forms of Mn⁴⁺ and Mn²⁺. Calculated by the element and based on the total content of Mn⁴⁺ and Mn²⁺, the content of Mn⁴⁺ was 80%, and the content of Mn²⁺ was 20%.

### EXAMPLE 2-5

Raw materials: γ-Al₂O₃ carrier (specific surface area 180 m²/g), sphere, average particle diameter 1.3 mm, a product from the Changling Catalyst Plant; Mn(NO₃)₂(50 wt % solution), Cu(NO₃)₂, and Na₂CO₃ were commercially available from the Beijing Chemical Works.

The sample was prepared by a step-wise impregnation process. A drying step at 110° C. was conducted for 12 hrs after each impregnation step, and then the resultant composition was baked at 750° C. for 4 hrs, and the other preparation steps were same to those in Example 2-1. The composition Na—Mn—Cu-γ-Al₂O₃ was prepared; calculated by Na/CO₃, MnO₂, and CuO respectively, the amount of Na was 8 wt %, the amount of Mn was 3 wt %, and the amount of Cu was 15 wt %.

As characterized by the X-ray photoelectron spectroscopy, Mn was present in at least the two different forms of Mn⁴⁺ and Mn²⁺. Calculated by the element and based on the total content of Mn⁴⁺ and Mn²⁺, the content of Mn⁴⁺ was 84%, and the content of Mn²⁺ was 16%.

### EXAMPLE 2-6

Raw materials: γ-Al₂O₃ carrier (specific surface area 180 m²/g), sphere, average particle diameter 1.3 mm, a product from the Changling Catalyst Plant; Mn(NO₃)₂(50 wt % solution), Zn(NO₃)₂, and Na₂CO₃ were commercially available from the Beijing Chemical Works.

The sample was prepared by a step-wise impregnation process. A drying step at 110° C. was conducted for 12 hrs after each impregnation step, and then the resultant composition was baked at 950° C. for 4 hrs, and the other preparation steps were same to those in Example 2-1. The composition Na—Mn—Zn-γ-Al₂O₃ was prepared; calculated by Na₂CO₃, MnO₂, and ZnO respectively, the amount of Na was 18 wt %, the amount of Mn was 8 wt %, and the amount of Zn was 10 wt %.

As characterized by the X-ray photoelectron spectroscopy, Mn was present in at least the two different forms of Mn⁴⁺ and Mn²⁺. Calculated by the element and based on the total content of Mn⁴⁺ and Mn²⁺, the content of Mn⁴⁺ was 77%, and the content of Mn²⁺ was 23%.

### EXAMPLE 2-7

The sorbent used in the experiment was those prepared in Examples 2-1, 2-2-1,2-2-2,2-2-3, 2-2-4 and 2-3. The experiment was conducted on a fixed bed continuous flow reactor. The reactor had an inside diameter of 8 mm. The sorbents were used in an amount of 1 g. The adsorption temperature was 175° C. The volume flow rate of the feedstock gas was 300 ml/min. The volume composition of the feedstock gas was: 0.3% SO₂; 0.1% NO; 4.5% O₂; and the balance being N₂. Before the feedstock gas was fed, the material bed layer for removing the sulfur and nitrogen substances was purged by N₂ in a volume flow rate of 300 ml/min at 300° C. for 1 hr and then cooled to the adsorption temperature. The adsorption experiment was stopped when the concentration of the adsorbed tail gas tended to be stable. A SO₂ and NO analysis instrument was connected to the exit of the reactor to monitor the changes of the amounts of SO₂ and NO in the flue gas. Regarding the Example 2-1 sorbent: the SO₂ saturated adsorption capacity was 1.320 mmol/g, and the NO saturated adsorption capacity was 0.446 mmol/g; regarding Example 2-2-1,2-2-2,2-2-3 and 2-2-4 sorbents: the SO₂ saturated adsorption capacity were 1.315, 1.270, 1.286, and 1.308 mmol/g respectively, and the NO saturated adsorption capacity were 0.440, 0.412, 0.420, and 0.429 mmol/g respectively; regarding Example 2-3 sorbent: the SO₂ saturated adsorption capacity was 1.319 mmol/g, and the NO saturated adsorption capacity was 0.434 mmol/g.

### COMPARATIVE EXAMPLE 2-4

The sorbents used in the experiment were those prepared in Comparative Examples 2-1, 2-2 and 2-3. The experiment was conducted on a fixed bed continuous flow reactor. The reactor had an inside diameter of 8 mm. The material for removing the sulfur and nitrogen substances was used in an amount of 1 g. The adsorption temperature was 50° C. The volume flow rate of the feedstock gas was 300 ml/min. The volume composition of the feedstock gas was: 0.3% SO₂; 0.1% NO; 4.5% O₂; and the balance being N₂. Before the feedstock gas was fed, the material bed layer for removing the sulfur and nitrogen substances was purged by N₂ in a volume flow rate of 300 ml/min at 300° C. for 1 hr and then cooled to the adsorption temperature. The adsorption experiment was stopped when the concentration of the adsorbed tail gas tended to be stable, and then N₂ was used to purge the residual mix gas in the tube wall for 10 mins. A SO₂ and NO analysis instrument was connected to the exit of the reactor to monitor the changes of the amounts of SO₂ and NO in the flue gas. In the experiment, regarding the sorbent prepared in Comparative Example 2-1: the SO₂ saturated adsorption capacity was 1.209 mmol/g, and the NO saturated adsorption capacity was 0.308 mmol/g; regarding the sorbent prepared in Comparative Example 2-2: the SO₂ saturated adsorption capacity was 1.130 mmol/g, and the NO saturated adsorption capacity was 0.297 mmol/g; regarding the sorbent prepared in Comparative Example 2-3: the SO₂ saturated adsorption capacity was 1.121 mmol/g, and the NO saturated adsorption capacity was 0.278 mmol/g.

### EXAMPLE 2-8

The sorbent to be regenerated was the adsorption-saturated sample in Example 2-7, represented by SORB2-1 (the sorbent of Example 2-1) and SORB2-2 (the sorbent of Example 2-2-1). The regeneration was conducted on an ex-situ regenerator which was a tube reactor having an inside diameter of 10 mm.

1 g SORB2-1 (or SORB2-2) to be regenerated was placed in the reactor device. The temperature in the reactor was increased to 350° C. in a temperature ramp rate of 10° C./min under the nitrogen purge in a space velocity of 10000/hr. After being stable for 30 mins, the nitrogen purge was stopped, and then at the regeneration temperature of 350° C., the SORB2-1 (or SORB2-2) to be regenerated was contacted with CO gas in a space velocity of 15000/hr for 2 hrs; the reactor was purged by nitrogen gas in a space velocity of 10000/hr for 30 mins, and then the SORB2-1 (or SORB2-2) reduced in the previous step was contacted with oxygen gas in a space velocity of 15000/hr for 30 mins; the reactor was purged by nitrogen gas in a space velocity of 10000/hr for 30 mins, and then the SORB2-1 (or SORB2-2) oxidized in the previous step was contacted with methane gas in a space velocity of 15000/hr for 1 hr; subsequently, nitrogen gas was fed in a space velocity of 10000/hr to purge the reactor until the temperature of the reactor was decreased to the ambient temperature. Accordingly, the regenerated sorbent composition SORB2-1-1 (or SORB2-2-1) was obtained.

The SORB2-1-1 and SORB2-2-1 were evaluated according to the evaluation conditions of Example 2-7. The experimental results were: regarding SORB2-1-1: the SO₂ saturated adsorption capacity was 1.152 mmol/g (87.3% of the capacity of the fresh sorbent), and the NO saturated adsorption capacity was 0.396 mmol/g (88.8% of the capacity of the fresh sorbent); regarding SORB2-2-1: the SO₂ saturated adsorption capacity was 1.205 mmol/g (91.6% of the capacity of the fresh sorbent), and the NO saturated adsorption capacity was 0.400 mmol/g (90.9% of the capacity of the fresh sorbent).

### COMPARATIVE EXAMPLE 2-5

The sorbent to be regenerated was the adsorption-saturated sample in Comparative Example 2-4, and the regeneration steps were same to those in Example 2-8.

The evaluation conditions for the regenerated sample were same to those in Comparative Example 2-4. The experimental results were: regenerated Comparative Example 2-1 sample: the SO₂ saturated adsorption capacity was 0.802 mmol/g (66.3% of the capacity of the fresh sorbent), and the NO saturated adsorption capacity was 0.224 mmol/g (72.7% of the capacity of the fresh sorbent); regenerated Comparative Example 2-2 sample: the SO₂ saturated adsorption capacity was 0.781 mmol/g (69.1% of the capacity of the fresh sorbent), and the NO saturated adsorption capacity was 0.215 mmol/g (72.4% of the capacity of the fresh sorbent); regenerated Comparative Example 2-3 sample: the SO₂ saturated adsorption capacity was 0.811 mmol/g (72.3% of the capacity of the fresh sorbent), and the NO saturated adsorption capacity was 0.202 mmol/g (72.7% of the capacity of the fresh sorbent).

### COMPARATIVE EXAMPLE 3-1

Raw materials: γ-Al₂O₃ carrier (specific surface area 180 m²/g), sphere, average particle diameter 1.3 mm, a product from the Changling Catalyst Plant; Mg(NO₃)₂ and Co(NO₃)₂ were commercially available from the Beijing Chemical Works.

Preparation method: 259 g Mg (NO₃)₂ was dissolved by deionized water to 1 liter solution L1, and 544 g Co(NO₃)₂ was dissolved by deionized water to 1 liter solution L2. 1000 g γ-Al₂O₃ carrier was sequentially impregnated with L1 and L2 for 2 hrs, a drying step was conducted at 110° C. for 12 hrs after each impregnation step, and the resultant mixture was baked at 600° C. for 10 hrs to obtain the composition Mg—Co-γ-Al₂O₃.

Composition: the loading amounts of the components were calculated by MgO and CO₃O₄ respectively; the amount of Mg was 7 wt %, and the amount of Co was 15 wt %.

As characterized by the X-ray photoelectron spectroscopy, in the composition, Co was present in only the form of Co⁴⁺.

### EXAMPLE 3-1

Raw materials: γ-Al₂O₃ carrier (specific surface area 180 m²/g), sphere, average particle diameter 1.3 mm, a product from the Changling Catalyst Plant; Mg(NO₃)₂ and Co(NO₃)₂ were commercially available from the Beijing Chemical Works.

Preparation method: 259 g Mg (NO₃)₂ was dissolved by deionized water to 1 liter solution L1, 544 g Co(NO₃)₂ was dissolved by deionized water to 1 liter solution L2. 1000 g γ-Al₂O₃ carrier was sequentially impregnated with L1 and L2 for 2 hrs, a drying step was conducted at 110° C. for 12 hrs after each impregnation step, and the resultant mixture was baked at 900° C. for 10 hrs to obtain the composition Mg—Co-γ-Al₂O₃.

Composition: the loading amounts of the components were calculated by MgO, and Co₃O₄ respectively; the amount of Mg was 7 wt %, and the amount of Co was 15 wt %.

As characterized by the X-ray photoelectron spectroscopy, the transition metal Co was present in at least the forms of Co³⁺ and Co⁴⁺ respectively. Calculated by the element and based on the total content of Co³⁺ and Co⁴⁺, the content of Co³⁺ was 17%, the content of Co⁴⁺ was 83%.

### EXAMPLE 3-2

Raw materials: silica carrier (specific surface area 162 m²/g), sphere, average particle diameter 1.22 mm, a product from the Changling Catalyst Plant; Co(NO₃)₂ and K₂CO₃ were commercially available from the Beijing Chemical Works.

Preparation method: the composition K—Co—SiO₂ was prepared by a step-wise impregnation process as disclosed in Example 3-1. A drying step at 110° C. was conducted for 12 hrs after each impregnation step, and then the resultant composition was baked at 750° C. for 8 hrs.

Composition: calculated by K₂CO₃ and CO₃O₄ respectively, the amount of K in the composition K—Co—SiO₂ was 4 wt %, and the amount of Co was 13 wt %.

As characterized by the X-ray photoelectron spectroscopy, in the composition, Co was present in at least the forms of Co³⁺ and Co⁴⁺ respectively. Calculated by the element and based on the total content of Co³⁺ and Co⁴⁺, the content of Co³⁺ was about 11%, and the content of Co⁴⁺ was about 89%.

### EXAMPLE 3-3

Raw materials: γ-Al₂O₃ carrier (same to Example 3-1); Ba(NO₃)₂, Co(NO₃)₂, and La(NO₃)₃ were commercially available from the Beijing Chemical Works.

Preparation method: the composition Ba—Co—La-γ-Al₂O₃ was prepared by a step-wise impregnation process as disclosed in Example 3-1. A drying step at 110° C. was conducted for 12 hrs after each impregnation step, the resultant was baked at 650° C. for 7 hrs.

Composition: calculated by BaO, La₂O₃ and CO₃O₄ respectively, the amount of Ba in Ba—Co—La-γ-Al₂O₃ was 4 wt %, the amount of La was 13 wt %, and the amount of Co was 5 wt %.

As characterized by the X-ray photoelectron spectroscopy, in the composition, Co was present in at least the forms of Co³⁺ and Co⁴⁺ respectively. Calculated by the element and based on the total content of Co³⁺ and Co⁴⁺, the content of Co³⁺ was 15%, and the content of Co⁴⁺ was 85%.

### EXAMPLE 3-4

Raw materials: γ-Al₂O₃ carrier (specific surface area 180 m²/g), sphere, average particle diameter 1.3 mm, a product from the Changling Catalyst Plant; Cr(NO₃)₃, Co(NO₃)₂, K₂CO₃, and CaCO₃ were commercially available from the Beijing Chemical Works.

Preparation method: the composition K—Co—Cr—Ca-γ-Al₂O₃ was prepared by a step-wise impregnation process as disclosed in Example 3-1. A drying step at 110° C. was conducted for 12 hrs after each impregnation step, and then the resultant composition was baked at 900° C. for 6 hrs.

Composition: calculated by K₂CO₃, Cr₂O₃, CO₃O₄, and CaO respectively, the amount of K in the composition K—Co—Cr—Ca-γ-Al₂O₃ was 7 wt %, the amount of Cr was 8 wt %, the amount of Co was 17 wt %, and the amount of Ca was 4 wt %.

As characterized by the X-ray photoelectron spectroscopy, in the composition, Co was present in at least the forms of Co³⁺ and Co⁴⁺ respectively. Calculated by the element and based on the total content of Co³⁺ and Co⁴⁺, the content of Co³⁺ was 15%, and the content of Co⁴⁺ was 85%.

### EXAMPLE 3-5

Raw materials: γ-Al₂O₃ carrier (specific surface area 180 m²/g), sphere, average particle diameter 1.3 mm, a product from the Changling Catalyst Plant; Mn(NO₃)₂(50 wt % solution), Co(NO₃)₂, and Na₂CO₃ were commercially available from the Beijing Chemical Works.

Preparation method: the composition Na—Mn—Co-γ-Al₂O₃ was prepared by a step-wise impregnation process as disclosed in Example 3-1. A drying step at 110° C. was conducted for 12 hrs after each impregnation step, the resultant was baked at 700° C. for 6 hrs.

Composition: calculated by Na₂CO₃, MnO₂, and CO₃O₄ respectively, the amount of Na in Na—Mn—Co-γ-Al₂O₃ was 16 wt %, the amount of Mn was 5 wt %, and the amount of Co was 13 wt %.

As characterized by the X-ray photoelectron spectroscopy, in the composition, Co was present in at least the forms of Co³⁺ and Co⁴⁺ respectively. Calculated by the element and based on the total content of Co³⁺ and Co⁴⁺, the content of Co³⁺ was 7%, and the content of Co⁴⁺ was 93%.

### EXAMPLE 3-6

Raw materials: γ-Al₂O₃ carrier (specific surface area 180 m²/g), sphere, average particle diameter 1.3 mm, a product from the Changling Catalyst Plant; Co(NO₃)₂, Cu(NO₃)₂, and Na₂CO₃ were commercially available from the Beijing Chemical Works.

Preparation method: the composition Na—Co—Cu-γ-Al₂O₃ was prepared by a step-wise impregnation process as disclosed in Example 3-1. A drying step at 110° C. was conducted for 12 hrs after each impregnation step, and then the resultant composition was baked at 750° C. for 5 hrs.

Composition: calculated by Na₂CO₃, CO₃O₄, and CuO respectively, the amount of Na in Na—Co—Cu-γ-Al₂O₃ was 8 wt %, the amount of Co was 3 wt %, and the amount of Cu was 15 wt %.

As characterized by the X-ray photoelectron spectroscopy, in the composition, Co was present in at least the forms of Co³⁺ and Co⁴⁺ respectively. Calculated by the element and based on the total content of Co³⁺ and Co⁴⁺, the content of Co³⁺ was 10%, and the content of Co⁴⁺ was 90%.

### EXAMPLE 3-7

Raw materials: γ-Al₂O₃ carrier (specific surface area 180 m²/g), sphere, average particle diameter 1.3 mm, a product from the Changling Catalyst Plant; Co(NO₃)₂, Zn(NO₃)₂, and Na₂CO₃ were commercially available from the Beijing Chemical Works.

Preparation method: the composition Na—Co—Zn-γ-Al₂O₃ was prepared by a step-wise impregnation process as disclosed in Example 3-1. A drying step at 110° C. was conducted for 12 hrs after each impregnation step, the resultant was baked at 950° C. for 4 hrs.

Composition: calculated by Na₂CO₃, CO₃O₄, and ZnO respectively, the amount of Na in Na—Co—Zn-γ-Al₂O₃ was 18 wt %, the amount of Co was 8 wt %, and the amount of Zn was 10 wt %.

As characterized by the X-ray photoelectron spectroscopy, in the composition, Co was present in at least the forms of Co³⁺ and Co⁴⁺ respectively. Calculated by the element and based on the total content of Co³⁺ and Co⁴⁺, the content of Co³⁺ was 13%, and the content of Co⁴⁺ was 87%.

### EXAMPLE 3-8

The sorbent used in the experiment was Mg—Co-γ-Al₂O₃ prepared in Example 3-1. The experiment was conducted on a fixed bed continuous flow reactor. The reactor had an inside diameter of 8 mm. The material for removing sulfur and nitrogen substances was used in an amount of 1 g. The adsorption temperature was 175° C. The volume flow rate of the feedstock gas was 300 ml/min. The volume composition of the feedstock gas was: 0.3% SO₂; 0.1% NO; 4.5% O₂; and the balance being N₂. Before the feedstock gas was fed, the material bed layer for removing the sulfur and nitrogen substances was purged by N₂ in a volume flow rate of 300 ml/min at 300° C. for 1 hr and then cooled to the adsorption temperature. The adsorption experiment was stopped when the concentration of the adsorbed tail gas tended to be stable. A SO₂ and NO analysis instrument was connected to the exit of the reactor to monitor the changes of the amounts of SO₂ and NO in the flue gas. In the experiment, the SO₂ saturated adsorption capacity was 1.256 mmol/g, and the NO saturated adsorption capacity was 0.431 mmol/g.

### COMPARATIVE EXAMPLE 3-2

The sorbent used in the experiment was Mg—Co-γ-Al₂O₃ prepared in Comparative Example 3-1. The experiment was conducted on a fixed bed continuous flow reactor. The reactor had an inside diameter of 8 mm. The material for removing the sulfur and nitrogen substances was used in an amount of 1 g. The adsorption temperature was 50° C. The volume flow rate of the feedstock gas was 300 ml/min. The volume composition of the feedstock gas was: 0.3% SO₂; 0.1% NO; 4.5% O₂; and the balance being N₂. Before the feedstock gas was fed, the material bed layer for removing the sulfur and nitrogen substances was purged by N₂ in a volume flow rate of 300 ml/min at 300° C. for 1 hr and then cooled to the adsorption temperature. The adsorption experiment was stopped when the concentration of the adsorbed tail gas tended to be stable, and then N₂ was used to purge the residual mix gas in the tube wall for 10 mins. A SO₂ and NO analysis instrument was connected to the exit of the reactor to monitor the changes of the amounts of SO₂ and NO in the flue gas. In the experiment, the SO₂ saturated adsorption capacity was 1.207 mmol/g, and the NO saturated adsorption capacity was 0.303 mmol/g.

### EXAMPLE 3-9

The sorbent to be regenerated was the adsorption-saturated sample in Example 3-8, represented by SORB3-1. The regeneration was conducted on an ex-situ regenerator which was a tube reactor having an inside diameter of 10 mm.

1 g SORB3-1 to be regenerated was placed in the reactor device. The temperature in the reactor was increased to 350° C. in a temperature ramp rate of 10° C./min under the nitrogen purge in a space velocity of 10000/hr. After being stable for 30 mins, the nitrogen purge was stopped, and then at the regeneration temperature of 350° C., the SORB3-1 to be regenerated was contacted with CO gas in a space velocity of 15000/hr for 2 hrs; the reactor was purged by nitrogen gas in a space velocity of 10000/hr for 30 mins, and then the SORB3-1 reduced in the previous step was contacted with oxygen gas in a space velocity of 15000/hr for 30 mins; the reactor was purged by nitrogen gas in a space velocity of 10000/hr for 30 mins, and then the SORB3-1 oxidized in the previous step was contacted with methane gas in a space velocity of 15000/hr for 1 hr; subsequently, nitrogen gas was fed in a space velocity of 10000/hr to purge the reactor until the temperature of the reactor was decreased to the ambient temperature. Accordingly, the regenerated sorbent composition SORB3-1-1 was obtained.

The SORB3-1-1 was evaluated according to the evaluation conditions of Example 3-8. The experimental results were: the SO₂ saturated adsorption capacity was 1.161 mmol/g (92.4% of the capacity of the fresh sorbent), and the NO saturated adsorption capacity was 0.402 mmol/g (93.3% of the capacity of the fresh sorbent).

### COMPARATIVE EXAMPLE 3-3

The sorbent to be regenerated was the adsorption-saturated sample in Comparative Example 3-2, and the regeneration steps were same to those in Example 3-9.

The evaluation conditions for the regenerated sample were same to those in Comparative Example 3-2. The experimental results of the regenerated Comparative Example 3-1 sample were: the SO₂ saturated adsorption capacity was 0.761 mmol/g (63.0% of the capacity of the fresh sorbent), and the NO saturated adsorption capacity was 0.189 mmol/g (62.3% of the capacity of the fresh sorbent).

### COMPARATIVE EXAMPLE 4-1

Raw materials: silica carrier (specific surface area 162 m²/g), sphere, average particle diameter 1.22 mm, a product from the Changling Catalyst Plant; Mg(NO₃)₂, Zn(NO₃)₂, and La(NO₃)₃ were commercially available from the Beijing Chemical Works.

Preparation method: 109.6 g Zn(NO₃)₃ was dissolved by deionized water to 1 liter solution L1, 172 g La(NO₃)₃ was dissolved by deionized water to 1 liter solution L2, and 592 g Mg(NO₃)₂ solution was dissolved by deionized water to 1 liter solution L3. 1000 g SiO₂ carrier was sequentially impregnated with L1, L2, and L3 for 2 hrs, a drying step was conducted at 110° C. for 12 hrs after each impregnation step, and the resultant mixture was baked at 600° C. for 10 hrs to obtain the composition La—Mg—Zn—SiO₂.

Composition: calculated by MgO, ZnO and La₂O₃ respectively, the amount of Mg was 16 wt %, the amount of Zn was 3 wt %, and the amount of La was 7 wt %.

As characterized by the X-ray photoelectron spectroscopy, in the composition, Zn was present only in the form of Zn²⁺.

### EXAMPLE 4-1

Raw materials: silica carrier (specific surface area 162 m²/g), sphere, average particle diameter 1.22 mm, a product from the Changling Catalyst Plant; Mg(NO₃)₂, Zn(NO₃)₂, and La(NO₃)₃ were commercially available from the Beijing Chemical Works.

Preparation method: 109.6 g Zn(NO₃)₂ was dissolved by deionized water to 1 liter solution 172 g La(NO₃)₃ was dissolved by deionized water to 1 liter solution L2, and 592 g Mg(NO₃)₂ solution was dissolved by deionized water to 1 liter solution L3. 1000 g SiO₂ carrier was sequentially impregnated with L1, L2, and L3 for 2 hrs, a drying step was conducted at 110° C. for 12 hrs after each impregnation step, and the resultant mixture was baked at 950° C. for 10 hrs to obtain the composition La—Mg—Zn—SiO₂.

Composition: calculated by MgO, ZnO and La₂O₃ respectively, the amount of Mg was 16 wt %, the amount of Zn was 3 wt %, and the amount of La was 7 wt %.

As characterized by the X-ray photoelectron spectroscopy, in the composition, Zn was present in at least the forms of Zn¹⁺ and Zn²⁺. Calculated by the element and based on the total content of Zn¹⁺ and Zn²⁺, the content of Zn¹⁺ was 13%, and the content of Zn²⁺ was 87%.

### EXAMPLE 4-2

Raw materials: γ-Al₂O₃ carrier (specific surface area 180 m²/g), sphere, average particle diameter 1.3 mm, a product from the Changling Catalyst Plant; Zn(NO₃)₂ and K₂CO₃ were commercially available from the Beijing Chemical Works.

Preparation method: the composition K—Zn-γ-Al₂O₃ was prepared by a step-wise impregnation process, as disclosed in Example 4-1. A drying step at 110° C. was conducted for 12 hrs after each impregnation step, and then the resultant composition was baked at 900° C. for 8 hrs.

Composition: calculated by K₂CO₃ and ZnO respectively, the amount of K in K—Zn-γ-Al₂O₃ was 4 wt %, and the amount of Zn was 17 wt %.

As characterized by the X-ray photoelectron spectroscopy, in the composition, Zn was present in at least the forms of Zn¹⁺ and Zn²⁺. Calculated by the element and based on the total content of Zn¹⁺ and Zn²⁺, the content of Zn¹⁺ was 15%, and the content of Zn²⁺ was 85%.

### EXAMPLE 4-3

Raw materials: γ-Al₂O₃ carrier (specific surface area 180 m²/g), sphere, average particle diameter 1.3 mm, a product from the Changling Catalyst Plant; Mn(NO₃)₂(50 wt % solution), Zn(NO₃)₂ and Na₂CO₃ were commercially available from the Beijing Chemical Works.

Preparation method: the composition Na—Mn—Zn-γ-Al₂O₃ was prepared by a step-wise impregnation process, as disclosed in Example 4-1. A drying step at 110° C. was conducted for 12 hrs after each impregnation step, and then the resultant was baked at 700° C. for 6 hrs.

Composition: calculated by Na₂CO₃, MnO₂, and ZnO respectively, the amount of Na in Na—Mn—Zn-γ-Al₂O₃ was 16 wt %, the amount of Mn was 8 wt %, and the amount of Zn was 15 wt %.

As characterized by the X-ray photoelectron spectroscopy, in the composition, Zn was present in at least the forms of Zn¹⁺ and Zn²⁺. Calculated by the element and based on the total content of Zn¹⁺ and Zn²⁺, the content of Zn¹⁺ was 17%, and the content of Zn²⁺ was 83%.

### EXAMPLE 4-4

Raw materials: γ-Al₂O₃ carrier (specific surface area 180 m²/g), sphere, average particle diameter 1.3 mm, a product from the Changling Catalyst Plant; Zn(NO₃)₂, Co(NO₃)₂, Na₂CO₃, and Ba(NO₃)₂ were commercially available from the Beijing Chemical Works.

Preparation method: the composition Na—Zn—Co—Ba-γ-Al₂O₃ was prepared by a step-wise impregnation process, as disclosed in Example 4-1. A drying step at 110° C. was conducted for 12 hrs after each impregnation step, and then the resultant was baked at 680° C. for 5 hrs.

Composition: calculated by Na₂CO₃, ZnO, CO₃O₄, and BaO respectively, the amount of Na in Na—Zn—Co—Ba-γ-Al₂O₃ was 3 wt %, the amount of Zn was 12 wt %, the amount of Co was 9 wt %, and the amount of Ba was 8 wt %.

As characterized by the X-ray photoelectron spectroscopy, in the composition, Zn was present in at least the forms of Zn¹⁺ and Zn²⁺. Calculated by the element and based on the total content of Zn¹⁺ and Zn²⁺, the content of Zn¹⁺ was 19%, and the content of Zn²⁺ was 81%.

### EXAMPLE 4-5

Raw materials: γ-Al₂O₃ carrier (specific surface area 180 m²/g), sphere, average particle diameter 1.3 mm, a product from the Changling Catalyst Plant; Cr(NO₃)₂, Zn(NO₃)₂, and Na₂CO₃ were commercially available from the Beijing Chemical Works.

Preparation method: the composition Na—Zn—Cr-γ-Al₂O₃ was prepared by a step-wise impregnation process, as disclosed in Example 4-1. A drying step at 110° C. was conducted for 12 hrs after each impregnation step, and then the resultant composition was baked at 750° C. for 4 hrs.

Composition: calculated by Na₂CO₃, Cr₂O₃, and ZnO respectively, the amount of Na in Na—Cr—Zn-γ-Al₂O₃ was 8 wt %, the amount of Cr was 3 wt %, and the amount of Zn was 15 wt %.

As characterized by the X-ray photoelectron spectroscopy, in the composition, Zn was present in at least the forms of Zn¹⁺ and Zn²⁺. Calculated by the element and based on the total content of Zn¹⁺ and Zn²⁺, the content of Zn¹⁺ was 21%, and the content of Zn²⁺ was 79%.

### EXAMPLE 4-6

Raw materials: γ-Al₂O₃ carrier (specific surface area 180 m²/g), sphere, average particle diameter 1.3 mm, a product from the Changling Catalyst Plant; Cu(NO₃)₂, Zn(NO₃)₂, and Na₂CO₃ were commercially available from the Beijing Chemical Works.

Preparation method: the composition Na— Cu —Zn-γ-Al₂O₃ was prepared by a step-wise impregnation process, as disclosed in Example 4-1. A drying step at 110° C. was conducted for 12 hrs after each impregnation step, and then the resultant composition was baked at 950° C. for 6 hrs.

Composition: calculated by Na₂CO₃, CuO, and ZnO respectively, the amount of Na in Na—Cu—Zn-γ-Al₂O₃ was 14 wt %, the amount of Zn was 8 wt %, and the amount of Zn was 12 wt %.

As characterized by the X-ray photoelectron spectroscopy, in the composition, Zn was present in at least the forms of Zn¹⁺ and Zn²⁺. Calculated by the element and based on the total content of Zn¹⁺ and Zn²⁺, the content of Zn¹⁺ was 14%, and the content of Zn²⁺ was 86%.

### EXAMPLE 4-7

The sorbent used in the experiment was La—Mg—Zn—SiO₂ prepared in Example 4-1. The experiment was conducted on a fixed bed continuous flow reactor. The reactor had an inside diameter of 8 mm. The material for removing sulfur and nitrogen substances was used in an amount of 1 g. The adsorption temperature was 175° C. The volume flow rate of the feedstock gas was 300 ml/min. The volume composition of the feedstock gas was: 0.3% SO₂; 0.1% NO; 4.5% O₂; and the balance being N₂. Before the feedstock gas was fed, the material bed layer for removing the sulfur and nitrogen substances was purged by N₂ in a volume flow rate of 300 ml/min at 300° C. for 1 hr and then cooled to the adsorption temperature. The adsorption experiment was stopped when the concentration of the adsorbed tail gas tended to be stable. A SO₂ and NO analysis instrument was connected to the exit of the reactor to monitor the changes of the amounts of SO₂ and NO in the flue gas, and the SO₂ and NO saturated adsorption capacities of the composition were calculated by the FIREFOX software. In the experiment, the SO₂ saturated adsorption capacity was 1.188 mmol/g, and the NO saturated adsorption capacity was 0.344 mmol/g.

### COMPARATIVE EXAMPLE 4-2

The sorbent used in the experiment was La—Mg—Zn—SiO₂ prepared in Comparative Example 4-1. The experiment was conducted on a fixed bed continuous flow reactor. The reactor had an inside diameter of 8 mm. The material for removing the sulfur and nitrogen substances was used in an amount of 1 g. The adsorption temperature was 50° C. The volume flow rate of the feedstock gas was 300 ml/min. The volume composition of the feedstock gas was: 0.3% SO₂; 0.1% NO; 4.5% O₂; and the balance being N₂. Before the feedstock gas was fed, the material bed layer for removing the sulfur and nitrogen substances was purged by N₂ in a volume flow rate of 300 ml/min at 300° C. for 1 hr and then cooled to the adsorption temperature. The adsorption experiment was stopped when the concentration of the adsorbed tail gas tended to be stable, and then N₂ was used to purge the residual mix gas in the tube wall for 10 mins. A SO₂ and NO analysis instrument was connected to the exit of the reactor to monitor the changes of the amounts of SO₂ and NO in the flue gas. In the experiment, the SO₂ saturated adsorption capacity was 1.153 mmol/g, and the NO saturated adsorption capacity was 0.323 mmol/g.

### EXAMPLE 4-8

The sorbent used in the experiment was Na— Cu —Zn-γ-Al₂O₃ prepared in Example 4-6. The experiment was conducted on a fixed bed continuous flow reactor. The reactor had an inside diameter of 8 mm. The material for removing sulfur and nitrogen substances was used in an amount of 1 g. The adsorption temperature was 100° C. The volume flow rate of the feedstock gas was 300 ml/min. The volume composition of the feedstock gas was: 0.3% SO₂; 0.1% NO; 4.5% O₂; and the balance being N₂. Before the feedstock gas was fed, the material bed layer for removing the sulfur and nitrogen substances was purged by N₂ in a volume flow rate of 300 ml/min at 300° C. for 1 hr and then cooled to the adsorption temperature. The adsorption experiment was stopped when the concentration of the adsorbed tail gas tended to be stable, and then N₂ was used to purge the residual mix gas in the tube wall for 10 mins. A SO₂ and NO analysis instrument was connected to the exit of the reactor to monitor the changes of the amounts of SO₂ and NO in the flue gas. In the experiment, the SO₂ saturated adsorption capacity was 1.180 mmol/g, and the NO saturated adsorption capacity was 0.340 mmol/g.

### EXAMPLE 4-9

The sorbent to be regenerated was the adsorption-saturated samples in Examples 4-8 and 4-7, represented by SORB4-1 (the sorbent of Example 4-6) and SORB4-2 (the sorbent of Example 4-1). The regeneration was conducted on an ex-situ regenerator which was a tube reactor having an inside diameter of 10 mm.

1 g SORB4-1 to be regenerated was placed in the reactor device. The temperature in the reactor was increased to 350° C. in a temperature ramp rate of 10° C./min under the nitrogen purge in a space velocity of 10000/hr. After being stable for 30 mins, the nitrogen purge was stopped, and then at the regeneration temperature of 350° C., the SORB4-1 to be regenerated was contacted with CO gas in a space velocity of 15000/hr for 2 hrs; the reactor was purged by nitrogen gas in a space velocity of 10000/hr for 30 mins, and then the SORB4-1 reduced in the previous step was contacted with oxygen gas in a space velocity of 15000/hr for 30 mins; the reactor was purged by nitrogen gas in a space velocity of 10000/hr for 30 mins, and then the SORB4-1 oxidized in the previous step was contacted with methane gas in a space velocity of 15000/hr for 1 hr; subsequently, nitrogen gas was fed in a space velocity of 10000/hr to purge the reactor until the temperature of the reactor was decreased to the ambient temperature. Accordingly, the regenerated sorbent composition SORB4-1-1 was obtained.

The SORB4-1-1 was evaluated according to the evaluation conditions of Example 4-8. The experimental result was: the SO₂ saturated adsorption capacity was 1.100 mmol/g (93.2% of the capacity of the fresh sorbent), and the NO saturated adsorption capacity was 0.297 mmol/g (87.3% of the capacity of the fresh sorbent).

SORB4-2 was tested similarly, except that the regeneration temperature was 500° C., and the times for contacting with the reductive or oxidative gas in regeneration steps (1), (2) and (3) were 3 hrs, 1.5 hrs and 1 hr respectively. The test results were: the SO₂ saturated adsorption capacity was 1.045 mmol/g (87.9% of the capacity of the fresh sorbent), and the NO saturated adsorption capacity was 0.276 mmol/g (80.2% of the capacity of the fresh sorbent).

### COMPARATIVE EXAMPLE 4-3

The sorbent to be regenerated was the adsorption-saturated sample in Comparative Example 4-2, and the regeneration steps were same to those for SORB4-1 in Example 4-9.

The evaluation conditions for the regenerated sample were same to those in Comparative Example 4-2. The experimental results of the regenerated Comparative Example 4-1 sample were: the SO₂ saturated adsorption capacity was 0.692 mmol/g (60.0% of the capacity of the fresh sorbent), and the NO saturated adsorption capacity was 0.164 mmol/g (50.8% of the capacity of the fresh sorbent).

Above experimental results were summarized in the following Table 1.

TABLE 1

| | | | | | | Adsorption properties | | | |
|---|---|---|---|---|---|---|---|---|---|
| | Composition of the sorbent | | | | | | | regenerated | regenerated |
| | Metal | Metal | | | Heating | | | SO₂ | NO |
| Example | component | component | | Other | temperature | SO₂ SAP | NO SAP | SAP/fresh | SAP/fresh |
| No. | I | II | Carrier | component | (° C.) | (mmol/g) | (mmol/g) | SO₂ SAP | NO SAP |
| Comparative | Mg | Cr | SiO2 | La | 600 | 1.201 | 0.310 | 63.3% | 58.6% |
| Example | | | | | | | | | |
| 1-1 | | | | | | | | | |
| Comparative | Ba | Mn | γ-Al₂O₃ | La | 600 | 1.209 | 0.308 | 66.3% | 72.7% |
| Example | | | | | | | | | |
| 2-1 | | | | | | | | | |
| Comparative | Na | Cu | γ-Al₂O₃ | La | 800 | 1.130 | 0.297 | 69.1% | 72.4% |
| Example | | | | | | | | | |
| 2-2 | | | | | | | | | |
| Comparative | Na | Mn | kaolin | La | 800 | 1.121 | 0.278 | 72.3% | 72.7% |
| Example | | | | | | | | | |
| 2-3 | | | | | | | | | |
| Comparative | Mg | Co | γ-Al₂O₃ | — | 600 | 1.207 | 0.303 | 63.0% | 62.3% |
| Example | | | | | | | | | |
| 3-1 | | | | | | | | | |
| Comparative | Mg | Zn | SiO₂ | La | 600 | 1.153 | 0.323 | 60.0% | 50.8% |
| Example | | | | | | | | | |
| 4-1 | | | | | | | | | |
| Example | Mg | Cr | SiO2 | La | 700 | 1.284 | 0.389 | 84.1% | 97.1% |
| 1-1 | | | | | | | | | |
| Example | K | Cr | γ-Al₂O₃ | — | 900 | | | | |
| 1-2 | | | | | | | | | |
| Example | Na | Cr + Mn | γ-Al₂O₃ | — | 800 | 1.337 | 0.446 | 89.8% | 92.3% |
| 1-3 | | | | | | | | | |
| Example | Na + Ba | Cr + Co | γ-Al₂O₃ | — | 680 | | | | |
| 1-4 | | | | | | | | | |
| Example | Na | Cr | γ-Al₂O₃ | Cu | 750 | | | | |
| 1-5 | | | | | | | | | |
| Example | Na | Cr + Zn | γ-Al₂O₃ | — | 950 | | | | |
| 1-6 | | | | | | | | | |
| Example | Ba | Mn | γ-Al₂O₃ | La | 900 | 1.320 | 0.446 | 87.3% | 88.8% |
| 2-1 | | | | | | | | | |
| Example | Na | Mn | γ-Al₂O₃ | La | 800 | 1.315 | 0.440 | 91.6% | 90.9% |
| 2-2-1 | | | | | | | | | |
| Example | Na | Mn | SiO2 | La | 800 | 1.270 | 0.412 | | |
| 2-2-2 | | | | | | | | | |
| Example | Na | Mn | SiO2 | La | 800 | 1.286 | 0.420 | | |
| 2-2-3 | | | | | | | | | |
| Example | Na | Mn | γ-Al₂O₃ | La | 800 | 1.308 | 0.429 | | |
| 2-2-4 | | | | | | | | | |
| Example | K | Mn | γ-Al₂O₃ | — | 750 | 1.319 | 0.434 | | |
| 2-3 | | | | | | | | | |
| Example | Na + | Mn + | γ-Al₂O₃ | — | 680 | | | | |
| 2-4 | Ba | Co | | | | | | | |
| Example | Na | Mn | γ-Al₂O₃ | Cu | 750 | | | | |
| 2-5 | | | | | | | | | |
| Example | Na | Mn + | γ-Al₂O₃ | — | 950 | | | | |
| 2-6 | | Zn | | | | | | | |
| Example | Mg | Co | γ-Al₂O₃ | — | 900 | 1.256 | 0.431 | 92.4% | 93.3% |
| 3-1 | | | | | | | | | |
| Example | K | Co | SiO₂ | — | 750 | | | | |
| 3-2 | | | | | | | | | |
| Example | Ba | Co | γ-Al₂O₃ | La | 650 | | | | |
| 3-3 | | | | | | | | | |
| Example | K + Ca | Co + | γ-Al₂O₃ | — | 900 | | | | |
| 3-4 | | Cr | | | | | | | |
| Example | Na | Co + | γ-Al₂O₃ | — | 700 | | | | |
| 3-5 | | Mn | | | | | | | |
| Example | Na | Co | γ-Al₂O₃ | Cu | 750 | | | | |
| 3-6 | | | | | | | | | |
| Example | Na | Co + | γ-Al₂O₃ | — | 950 | | | | |
| 3-7 | | Zn | | | | | | | |
| Example | Mg | Zn | SiO₂ | La | 950 | 1.188 | 0.344 | 87.9% | 80.2% |
| 4-1 | | | | | | | | | |
| Example | K | Zn | γ-Al₂O₃ | — | 900 | | | | |
| 4-2 | | | | | | | | | |
| Example | Na | Zn + | γ-Al₂O₃ | — | 700 | | | | |
| 4-3 | | Mn | | | | | | | |
| Example | Na + | Zn + | γ-Al₂O₃ | — | 680 | | | | |
| 4-4 | Ba | Co | | | | | | | |
| Example | Na | Zn + Cr | γ-Al₂O₃ | — | 750 | | | | |
| 4-5 | | | | | | | | | |
| Example | Na | Zn | γ-Al₂O₃ | Cu | 950 | 1.180 | 0.340 | 93.2% | 87.3% |
| 4-6 | | | | | | | | | |

* SAP: saturated adsorption capacity

1. A sorbent composition comprising
at least one refractory inorganic oxide matrix,
at least one metal component I and
at least one metal component II,
wherein
each of the at least one refractory inorganic oxide matrix has a specific surface area of more than 130 m²/g,
the at least one metal component I is selected element of Group IA and Group IIA in the Periodic Table of Elements,
the at least one metal component II is selected from transition metals of Group IIB, Group VIB, Group VIIB, and Group VIII in the Periodic Table of Elements, and
the at least one metal component II is present in at least two different valence-states, as characterized by the X-ray photoelectron spectroscopy.

2. The sorbent composition according to claim 1, wherein the at least one metal component II is selected from Zn of Group IIB, Cr of Group VIB, Mn of Group VIIB, and Co of Group VIII.

3. The sorbent composition according to claim 1, wherein the at least one metal component II comprises Mn of Group VIIB.

4. The sorbent composition according to claim 1, wherein the specific surface area of each of the at least one refractory inorganic oxide matrix is more than 150 m²/g.

5. The sorbent composition according to claim 1, wherein the at least one refractory inorganic oxide matrix is selected from alumina, silica, and silica-alumina.

6. The sorbent composition according to claim 1, wherein the at least one refractory inorganic oxide matrix is γ-Al₂O₃.

7. The sorbent composition according to claim 1, wherein the at least one metal component I is selected from Na and K of Group IA, and Ba, Mg, and Ca of Group IIA.

8. The sorbent composition according to claim 1, wherein the at least one metal component I is selected from Na and K of Group IA.

9. The sorbent composition according to claim 1, wherein the sorbent composition consists of the at least one metal component I, the at least one metal component II and the at least one refractory inorganic oxide matrix, wherein the components I and II can be present in one or more form(s) selected from the oxides and/or salts with other components.

10. The sorbent composition according to claim 1, wherein the sorbent composition comprises, based on the composition, the at least one refractory inorganic oxide matrix in an amount ranging from 50 to 99 wt %, the at least one metal component I in an amount ranging from 0.5 to 35 wt %, and the at least one metal component II in an amount ranging from 0.5 to 35 wt %, wherein the amounts of the at least one metal component I and the at least one metal component II are calculated by the oxide thereof.

11. The sorbent composition according to claim 1, wherein the sorbent composition comprises, based on the composition, the at least one refractory inorganic oxide matrix in an amount ranging from 65 to 98 wt %, the at least one metal component I in an amount ranging from 1 to 20 wt %, and the at least one metal component II in an amount ranging from 1 to 18 wt %, wherein the amounts of the at least one metal component I and the at least one metal component II are calculated by the oxide thereof.

12. The sorbent composition according to claim 1, wherein the at least one metal component II comprises Cr which is present in the valence-states of Cr⁶⁺ and Cr³⁺; calculated by the element and based on the total content of Cr, the content of Cr³⁺ is 90 to 70%, and the content of Cr⁶⁺ is 10% to 30%.

13. The sorbent composition according to claim 1, wherein the at least one metal component II comprises Mn which is present in the valence-states of Mn⁴⁺ and Mn²⁺; calculated by the element and based on the total content of Mn, the content of Mn²⁺ is 10 to 30%, and the content of Mn⁴⁺ is 70 to 90%.

14. The sorbent composition according to claim 1, wherein the at least one metal component II comprises Co which is present in the valence-states of Co³⁺ and Co⁴⁺; calculated by the element and based on the total content of Co, the content of Co³⁺ is 10 to 30%, and the content of Co⁴⁺ is 70 to 90%.

15. The sorbent composition according to claim 1, wherein the at least one metal component H comprises Zn which is present in the valence-states of Zn¹⁺ and Zn²⁺; calculated by the element and based on the total content of Zn, the content of Zn¹⁺ is 10 to 28%, and the content of Zn²⁺ is 72 to 90%.

16. A method for preparing the sorbent composition according to claim 1, comprising the following steps:
(1) combining the at least one metal component I and the at least one metal component II with the at least one refractory inorganic oxide matrix, wherein each of said at least one refractory inorganic oxide matrix has a specific surface of more than 130 m²/g and/or the precursor thereof, wherein the at least one metal component I is selected from elements of Group IA and Group IIA in the Periodic Table of Elements, and the at least one metal component II is selected from transition metals of Group IIB, Group VIB, Group VIIB, and Group VIII in the Periodic Table of Elements; and
(2) heating the product obtained from above step (1) at a temperature ranging from 600° C. to 1100° C. for a time period ranging from 2 to 12 hrs, to obtain the sorbentcomposition.

17. The method according to claim 16, wherein the heating temperature in the step (2) ranges from 620° C. to 1000° C.

18. The method according to claim 16, wherein the heating temperature in the step (2) ranges from 650° C. to 960° C.

19. The method according to claim 16, wherein the heating temperature in the step (2) ranges from 700° C. to 800° C.

20. A process for removing the nitrogen oxides and/or sulfur oxides in the flue gas, comprising, under the conditions for the adsorptive separation, contacting the flue gas containing nitrogen oxides and/or sulfur oxides with the sorbent composition according to claim 1 or the sorbent composition prepared according to the method of claim 16.

21. The process according to claim 20, wherein the conditions for the adsorptive separation comprises: a temperature ranging from 0 to 300° C.; a volume space velocity of the feedstock gases ranging from 5000/hr to 50000/hr; and a pressure ranging from 0.1 to 3 MPa.

22. The process according to claim 20, wherein the conditions for the adsorptive separation comprises: a temperature ranging from 0 to 100° C.; a volume space velocity of the feedstock gases ranging from 5000/hr to 35000/hr; and a pressure ranging from 0.1 to 2 MPa.

23. The process according to claim 20, wherein the process further comprises:
(1) contacting the composition with at least one reductive gas at a temperature ranging from 200° C. to 800° C. for a time period ranging from 0.5 to 5 hrs;
(2) contacting the product obtained in above step (1) with at least one oxygen-containing gas at a temperature ranging from 200° C. to 800° C. for a time period ranging from 0.5 to 3 hrs; and
(3) again contacting the product obtained in step (2) with at least one reductive gas at a temperature ranging from 200° C. to 800° C. for a time period ranging from 0.5 to 5 hrs, wherein the at least one reductive gas is same or different to that in above step (1).

24. The process according to claim 23, wherein the temperature in the step (1) ranges from 280° C. to 650° C., the temperature in the step (2) ranges from 280° C. to 650° C., and the temperature in the step (3) ranges from 280° C. to 650° C.

25. The process according to claim 23, wherein the contacting time in the step (1) ranges from 0.5 hr to 3.5 hrs, the contacting time in the step (2) ranges from 0.5 hr to 2.5 hrs, and the contacting time in the step (2) ranges from 0.5 hr to 3.5 hrs.
